(19) United States
(12) Patent Application Publication
(10) Pub. No.: US 2024/0405869 A1
(43) Pub. Date: Dec. 5, 2024

(54) RAMAN AMPLIFICATION DEVICE AND RAMAN AMPLIFICATION METHOD

(71) Applicant: Fujitsu Limited, Kawasaki-shi (JP)

(72) Inventors: Yusaku YAMAMOTO, Kawasaki (JP); Tomoaki WATANABE, Kawasaki (JP); Yukiko TSUBONO, Kyoto (JP); Yoshito KACHITA, Kawasaki (JP)

(73) Assignee: Fujitsu Limited, Kawasaki-shi (JP)

(21) Appl. No.: 18/674,167

(22) Filed: May 24, 2024

(30) Foreign Application Priority Data
May 31, 2023 (JP) 2023-089906
May 9, 2024 (JP) 2024-076846

(51) Int. Cl. H04B 10/079; G08B 21/18; H04B 10/077

(52) U.S. Cl. CPC H04B 10/0797; H04B 10/0777; G08B 21/182

(57) ABSTRACT

A Raman amplification device that Raman-amplifies an optical signal in a transmission line by Raman pumping, the Raman amplification device includes a processor configured to monitor a first signal communicated by the optical signal, set a threshold level of an alarm (WDMLOS) detection for determining whether the alarm is output at a time of transmission line disconnection in accordance with a monitoring result of the first signal, determine whether auto power shut down (APSD) control is performed by using a first APSD determination condition based on integration of optical supervisory channel (OSC) disconnection and the alarm, in a case where the monitoring result of the communicated first signal exceeds a predetermined condition, and determine whether the APSD control is performed by using a second APSD determination condition based on the OSC disconnection, in a case where the monitoring result of the communicated first signal is lower than the predetermined condition.

### CROSS-REFERENCE TO RELATED APPLICATION

This application is based upon and claims the benefit of priority of the prior Japanese Patent Application Nos. 2023-89906, filed on May 31, 2023,and 2024-76846, filed on May 9, 2024, the entire contents of which are incorporated herein by reference.

### FIELD

The embodiment discussed herein is related to a Raman amplification device and a Raman amplification method.

### BACKGROUND

A Raman amplification device optically amplifies an optical signal in a transmission line such as an optical fiber based on Raman pumping light. The Raman amplification device has a safety control function of output light cutoff by auto power shut down (APSD), and suppresses a situation in which a laser beam having light power is radiated to an outside and causes harm to a human body. The APSD stops output of an optical amplifier when detecting that an optical fiber end is released.

As a related art, for example, there is a technology in which a noise light component such as ASE in a wavelength range other than a wavelength band of wavelength-multiplexed optical WDM is absorbed, and disconnection of an optical signal is detected without being affected by an increase or decrease in a number of wavelengths. There is a technology in which, at a time of a link failure in a West-East link, an East Raman module stops a Raman pump based on a fact that a pilot signal does not arrive, and stops a West Raman pump by transmitting a failure signal to a West link. There is a technology in which a WDM signal is transmitted between a plurality of nodes, and a booster EDFA of each node switches from AGC to an APC method with low power in accordance with an in-band IB signal and an out-of-band OB signal via an OSC. There is a technology in which, in addition to the function of the OSC, as management data such as a number of multiplexed wavelengths of a signal of a general line, a supervisory channel (SV) signal including the number of multiplexed wavelengths extracted from the WDM signal is transmitted and received between the nodes via an inter-OSC communication bus different from a transmission line of a main signal.

The WDM described above is an abbreviation for wavelength division multiplexing. The ASE is an abbreviation for amplified spontaneous emission. The EDFA is an abbreviation for erbium doped fiber amplifier, and the OSC is an abbreviation for optical supervisory channel. The AGC is an abbreviation for auto gain control, and the APC is an abbreviation for auto power control.

Japanese Laid-open Patent Publication Nos. 2006-66610 and 2006-279355, and U.S. Patent Application Publication Nos. 2010/0080553 and 2009/0142061 are disclosed as related art.

### SUMMARY

According to an aspect of the embodiment, a Raman amplification device that Raman-amplifies an optical signal in a transmission line by Raman pumping, the Raman amplification device includes a memory, and a processor coupled to the memory and configured to monitor a first signal communicated by the optical signal, set a threshold level of an alarm (WDMLOS) detection for determining whether the alarm is output at a time of transmission line disconnection in accordance with a monitoring result of the first signal, determine whether auto power shut down (APSD) control is performed by using a first APSD determination condition based on integration of optical supervisory channel (OSC) disconnection and the alarm, in a case where the monitoring result of the communicated first signal exceeds a predetermined condition, and determine whether the APSD control is performed by using a second APSD determination condition based on the OSC disconnection, in a case where the monitoring result of the communicated first signal is lower than the predetermined condition.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram of a Raman amplification device according to an embodiment;

FIGS. 2A and 2B are explanatory diagrams of a problem occurring in an existing technology (part 1: at a time of a transmission line failure);

FIGS. 3A and 3B are explanatory diagrams of a problem occurring in the existing technology (part 2: at a time of an OSC failure);

FIG. 4A is an explanatory diagram of an influence of Raman noise occurring in backward Raman pumping (part 1);

FIG. 4B is an explanatory diagram of the influence of the Raman noise occurring in the backward Raman pumping (part 2);

FIG. 4C is an explanatory diagram of the influence of the Raman noise occurring in the backward Raman pumping (part 3);

FIG. 5 is an explanatory diagram of a control example in the Raman amplification device according to the embodiment;

FIG. 6 is a functional block diagram of the Raman amplification device according to the embodiment;

FIG. 7 is a diagram illustrating a hardware configuration example of a control unit of the Raman amplification device;

FIG. 8 is a flowchart illustrating an overview of a processing example of APSD control performed by the Raman amplification device;

FIG. 9 is a chart illustrating an example of setting a WDMLOS detection threshold;

FIG. 10A is a chart illustrating a specific example of setting reference values of a WDMLOS detection threshold and a number of wavelengths (part 1);

FIG. 10B is a chart illustrating a specific example of setting the reference values of the WDMLOS detection threshold and the number of wavelengths (part 2);

FIG. 11 is a chart illustrating an example of setting an APSD determination condition; and

FIG. 12 is a flowchart illustrating an example of overall processing of the APSD control performed by the Raman amplification device.

### DESCRIPTION OF EMBODIMENT

Even in a communication state in which there is no problem with a main signal in a system in which a Raman amplification device of a downstream node performs backward Raman pumping (backward Raman), when OSC disconnection occurs, an APSD function operates due to an influence of Raman noise, and main signal disconnection may occur.

Hereinafter, an embodiment of techniques to suppress APSD at the time of OSC disconnection in a communication state of a main signal in a Raman amplification device that performs Raman pumping will be described in detail with reference to the drawings.

### EMBODIMENT

### Configuration Example of Raman Amplification Device According to Embodiment

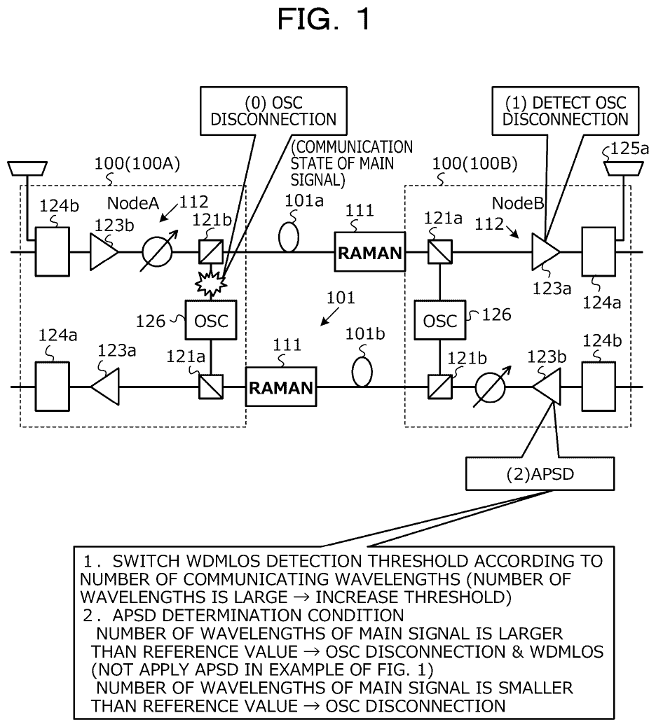

FIG. 1 is an explanatory diagram of a Raman amplification device according to an embodiment. According to an example illustrated in FIG. 1, Raman amplification devices 100 are disposed in an upstream NodeA and a downstream NodeB with the same configuration respectively, and transmit WDM light (main signal) via a transmission line 101 such as an SMF. The SMF is an abbreviation for single mode optical fiber.

The transmission line 101 includes a downlink transmission line 101a from an upstream (NodeA) Raman amplification device 100A to a downstream (NodeB) Raman amplification device 100B. The transmission line 101 also includes an uplink transmission line 101b from the downstream (NodeB) Raman amplification device 100B to the upstream (NodeA) Raman amplification device 100A.

A configuration example in a case where the downstream (NodeB) Raman amplification device 100B is a station of interest will be described below. The Raman amplification device 100 (100B) includes a Raman amplifier 111 and a ROADM 112. The “ROADM” is an abbreviation for reconfigurable optical add/drop multiplexer.

In FIG. 1, the Raman amplifier 111 includes a Raman pumping source therein and performs Raman pumping on the transmission line 101a by backward Raman pumping. The Raman amplifier 111 may perform Raman pumping by forward pumping and Raman pumping in which forward pumping and backward pumping are combined. In the forward pumping, the Raman amplifier 111 is provided on the Raman amplification device 100A side to perform forward pumping on the transmission line 101a. The ROADM 112 includes multiplexers/demultiplexers 121, optical amplifiers 123, wavelength selective switches (WSS) 124, a multiplexer (MUX/DEMUX) 125, and an OSC light transmission/reception unit 126. The WSS is an abbreviation for wavelength selective switch.

As viewed along a path of the downlink transmission line 101a, a multiplexer/demultiplexer 121a demultiplexes a wavelength band of OSC light for monitoring from an optical signal over the transmission line 101a and outputs the wavelength band to the OSC light transmission/reception unit 126. The OSC light transmission/reception unit 126 performs control based on a control signal included in the OSC light transmitted from the upstream (NodeA) Raman amplification device 100A.

For example, for an optical amplifier 123a, an EDFA is used and the optical amplifier 123a optically amplifies the optical signal over the transmission line 101a. A WSS 124a performs adding and dropping of an arbitrary optical signal to and from the transmission line 101a. A multiplexer 125a multiplexes the optical signal input to and output from the WSS 124.

As viewed along a path of the uplink transmission line 101b, a WSS 124b performs adding and dropping of an arbitrary optical signal to and from the transmission line 101b. An optical amplifier 123b optically amplifies an optical signal over the transmission line 101b. The OSC light transmission/reception unit 126 causes failure information detected by the corresponding Raman amplification device 100B to be included in the OSC light. The OSC light is multiplexed with the main signal in the uplink transmission line 101b via the multiplexer/demultiplexer 121b, and is transmitted to the upstream (NodeA) Raman amplification device 100A.

A configuration example of the upstream (NodeA) Raman amplification device 100A is substantially the same as that of the downstream (NodeB) Raman amplification device 100B described above, and the same constituent elements are denoted by the same reference signs.

The Raman amplification device 100B according to the embodiment performs following controls in 1. and 2.
1. A WDMLOS detection threshold is switched in accordance with a number of wavelengths of a communicated main signal. For example, in a case where the number of wavelengths is larger than a predetermined number of wavelengths, the WDMLOS detection threshold is increased accordingly. The WDMLOS is an alarm for notifying a loss state (loss of signal) in which the main signal of the WDM does not reach a reception unit due to fiber disconnection or the like of the transmission line 101.

According to FIG. 1 and the embodiment, a control (referred to as wavelength number control) based on the “number of wavelengths” of the communicated main signal will be described. Alternatively, a control (referred to as power control) based on the “power” of the communicated main signal may be performed. The “number of wavelengths” and the “power” of the main signal have an equivalent relationship. Therefore, the “number of wavelengths” described in FIG. 1 may be replaced with “power”. In the power control described below, for example, control is performed based on the power of the entire band of the WDM main signal (total power). Further, the power control may be performed based on not only the total power but also the power of a predetermined wavelength, for example, the power of a predetermined wavelength or the power of a plurality of wavelengths. When the control of the above 1. is performed by the power control, the detection thresholds of WDMLOS are switched according to the total power of the communicated main signal.

2. An APSD determination condition is switched in accordance with a number of wavelengths of a main signal. The Raman amplification device 100B that is the station of interest (NodeB) performs APSD control based on a preset APSD determination condition, but switches the APSD determination condition in accordance with the number of wavelengths of the main signal. Further, when the control of 2. is performed by the power control, the APSD determination condition is switched according to the total power of the communicated main signal.

The WDMLOS detection threshold may be set according to the power or the number of wavelengths of the communicated main signal. For example, the WDMLOS detection threshold may be variably set according to the power or the number of wavelengths of the communicated main signal, or may be set to a fixed value as follows. For example, as the number of wavelengths of the main signal becomes larger, minimum main signal power becomes higher. In this case, the Raman amplification device 100B performs switching of setting to a first set value that increases the WDMLOS detection threshold from a reference value of an initial value. “APSD determination condition 1=AND (integration) of OSC disconnection and WDMLOS detection” is set as a determination condition. Accordingly, when main signal disconnection (including the OSC disconnection) occurs, it is possible to output a WDMLOS based on the WDMLOS detection threshold and apply APSD based on the main signal disconnection. In a case where only a sudden failure of an OSC (OSC disconnection) occurs, it is possible to avoid an influence on the main signal in the communication state without applying APSD.

In a case where the number of wavelengths of the main signal decreases, the Raman amplification device 100B switches the APSD determination condition to “APSD determination condition 2=OSC disconnection only”. At this time, the WDMLOS detection threshold is switched to a second set value. The second set value is different from the first set value and is lower than the first set value. For example, when the number of wavelengths of the main signal decreases from the reference number of wavelengths after the WDMLOS detection threshold is operated at the initial value, the second setting value is maintained at the initial value (reference value) and the setting is not changed. This is based on the fact that an operation with a small number of wavelengths equal to or less than the predetermined number of wavelengths is rare. When the number of wavelengths of the main signal decreases during the operation with the WDMLOS detection threshold set to the first set value, the WDMLOS detection threshold is changed to the second set value (corresponding to the reference value) lower than the first set value. Accordingly, the APSD may be applied based on (1) OSC disconnection. Further, in the power control, when the total power of the communicated main signal decreases, the Raman amplification apparatus 100 switches the APSD determination condition to APSD determination condition 2=OSC disconnection only.

As a specific example, for example, as illustrated in FIG. 1, a state is assumed in which the number of wavelengths of the main signal communicated with the Raman amplification device 100A of the NodeA is larger than a certain reference number of wavelengths. It is assumed that, although the main signal disconnection is not detected, (0) the OSC disconnection of the OSC light from the Raman amplification device 100A of the NodeA has occurred.

In this case, the Raman amplification device 100B (1) detects the OSC disconnection by the optical amplifier 123a, and does “not apply” (2) APSD by the optical amplifier 123b based on “APSD determination condition=OSC disconnection & WDMLOS”. “Not apply” APSD refers to control of “not performing” output light cutoff by the APSD. “Apply” APSD refers to control of “performing” output light cutoff by the APSD.

In a case where the number of wavelengths of the main signal decreases from the reference number of wavelengths, the Raman amplification device 100B “applies” APSD when the OSC disconnection is detected based on “APSD determination condition=OSC disconnection”.

As illustrated in FIG. 1, in a normal communication state in which fiber disconnection (main signal disconnection) of the transmission line 101 has not occurred, when the number of wavelengths is larger than the reference number of wavelengths, the Raman amplification device 100B that performs backward Raman pumping according to the embodiment does not apply the APSD (not perform output light cutoff) only with the OSC disconnection. Details of the relationship between the generated Raman noise, the number of wavelengths of the main signal, and the WDMLOS detection threshold will be described later. Accordingly, the control of the APSD may be executed with higher accuracy without being affected by the Raman noise. The APSD control may be executed based on the power control, not limited to the number of wavelengths as described above.

### Problem of Existing Technology

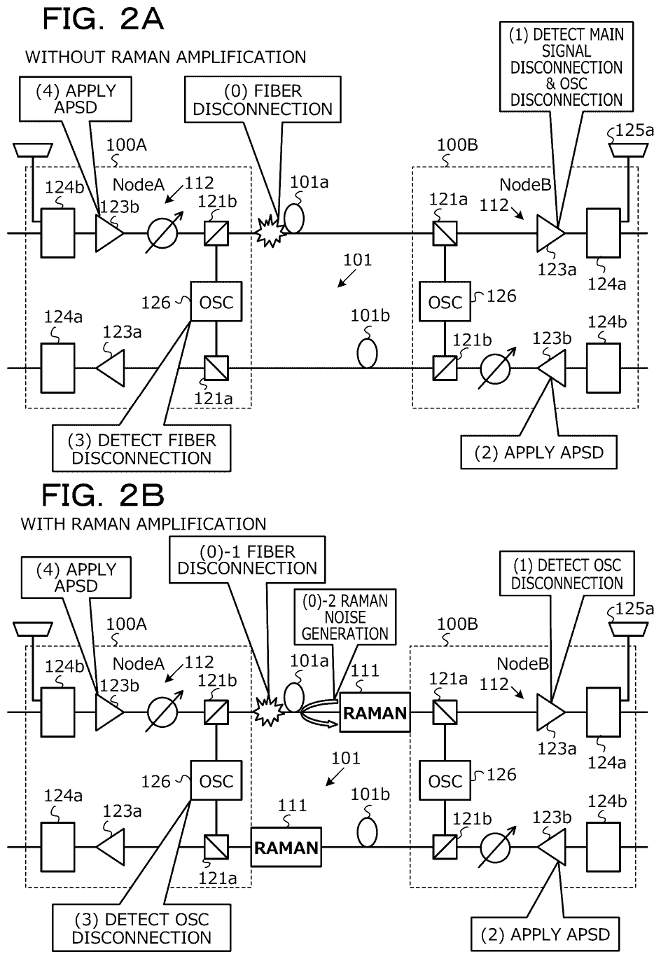

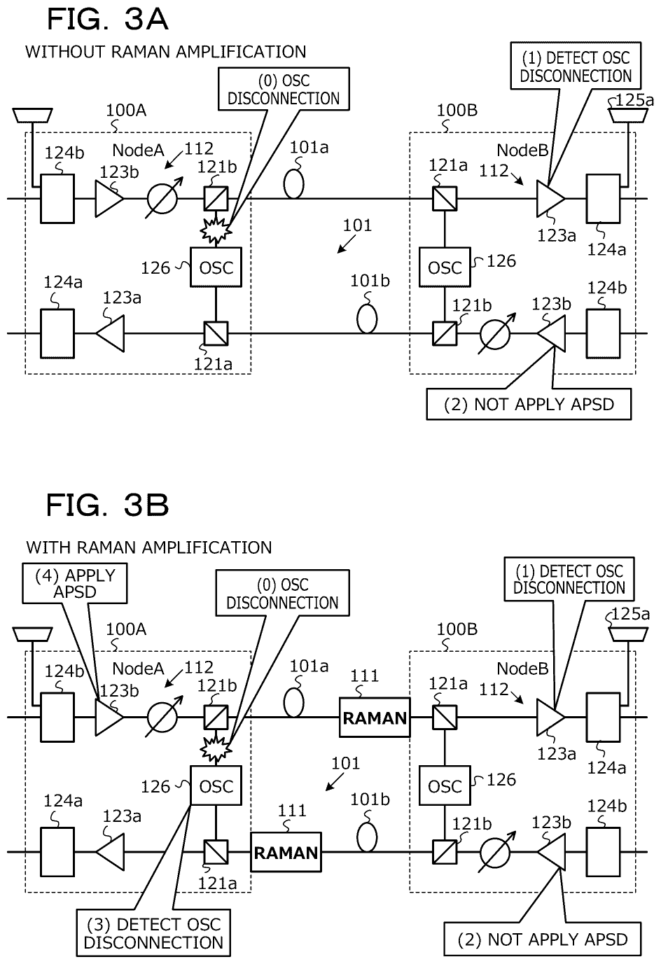

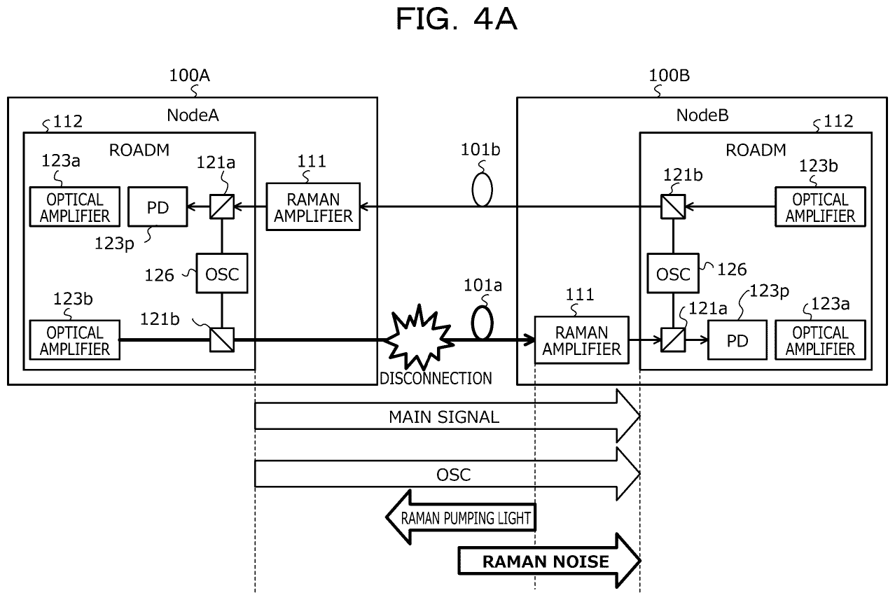

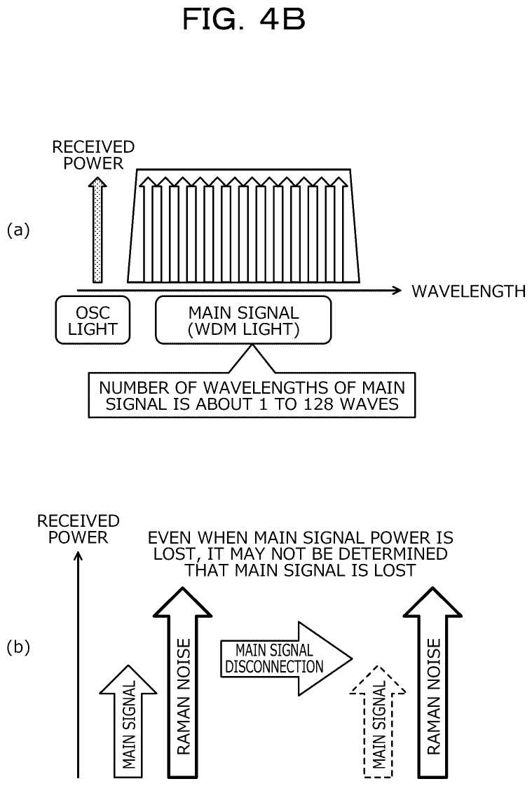

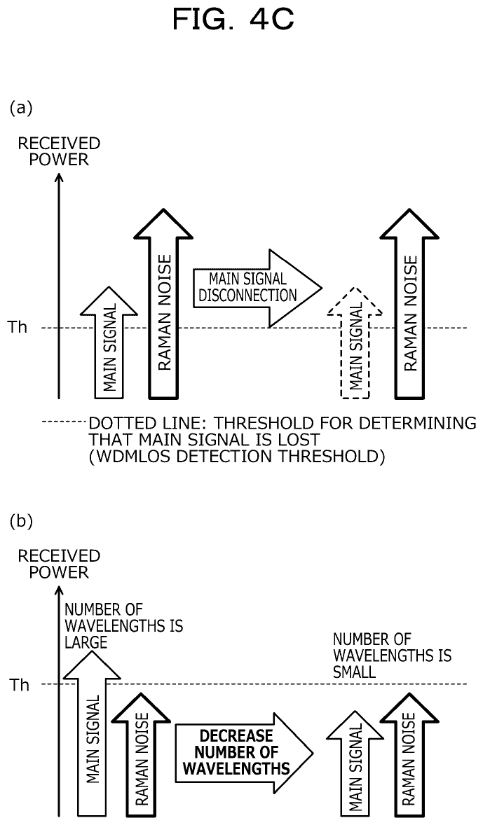

The problem occurring in the existing technology will be described. FIGS. 2A to 3B are explanatory diagrams of a problem occurring in the existing technology, and FIGS. 4A to 4C are explanatory diagrams of an influence of the Raman noise occurring in the backward Raman pumping.

First, FIGS. 2A and 2B illustrate an APSD control state at a time of a transmission line failure. FIG. 2A illustrates a ROADM without Raman amplification, and FIG. 2B illustrates a ROADM with Raman amplification. For convenience, in both of FIGS. 2A and 2B, constituent elements similar to those of the Raman amplification device 100 with Raman amplification described with reference to FIG. 1 are denoted by the same reference signs.

For the ROADM without Raman amplification illustrated in FIG. 2A, it is assumed that (0) fiber disconnection (transmission line disconnection) has occurred in the transmission line 101 between the NodeA (100A) and the NodeB (100B). In this case, (1) in the NodeB (100B), the optical amplifier 123a detects main signal disconnection and OSC disconnection. Although not illustrated in FIG. 2A, the optical amplifier 123a includes a photodetector (PD), and the PD detects the main signal disconnection.

(2) In the NodeB (100B), the optical amplifier 123b applies APSD. Accordingly, (3) the NodeA (100A) detects fiber disconnection, and (4) applies the APSD. As described above, an APSD determination condition in the ROADM without Raman amplification=main signal disconnection & OSC disconnection.

By contrast, in the ROADM with Raman amplification illustrated in FIG. 2B, it is assumed that (0)-1: fiber disconnection (transmission line disconnection) has occurred in the transmission line 101 between the NodeA (100A) and the NodeB (100B). In this case, (0)-2: Raman noise (Raman noise power) having predetermined power is generated over the transmission line 101 by Raman noise light that returns at a fiber disconnected portion due to the backward Raman pumping of the Raman amplifier 111. In this case, (1) in the NodeB (100B), the main signal disconnection may not be detected due to the influence of the Raman noise, and the optical amplifier 123a detects only OSC disconnection.

For this reason, in the ROADM with Raman amplification, (2) in the NodeB (100B), the optical amplifier 123b applies APSD based on the OSC disconnection. Accordingly, (3) the NodeA (100A) detects the OSC disconnection and (4) applies the APSD. Thus, an APSD determination condition in the ROADM with Raman amplification=OSC disconnection. As described above, since the main signal disconnection may not be correctly detected in the ROADM with Raman amplification, main signal disconnection may not be set as the APSD determination condition.

FIGS. 3A and 3B illustrate an APSD control state at the time of the OSC failure. FIG. 3A illustrates a ROADM without Raman amplification, and FIG. 3B illustrates a ROADM with Raman amplification.

For the ROADM without Raman amplification illustrated in FIG. 3A, it is assumed that (0) OSC disconnection has occurred in the NodeA (100A). In this case, (1) in the NodeB (100B), the optical amplifier 123a detects the OSC disconnection. (2) The optical amplifier 123b of the NodeB (100B) does not apply APSD. As described above, since the APSD determination condition of the ROADM without Raman amplification=main signal disconnection & OSC disconnection, the APSD is not applied only with the OSC disconnection.

By contrast, in the ROADM with Raman amplification illustrated in FIG. 3B, it is assumed that (0): OSC disconnection has occurred in the NodeA (100A). In this case, (1) in the NodeB (100B), the optical amplifier 123a detects the OSC disconnection.

(2) In the NodeB (100B), the optical amplifier 123b applies the APSD based on the OSC disconnection. Accordingly, (3) the NodeA (100A) detects the OSC disconnection and (4) applies the APSD. As described above, the APSD determination condition in the ROADM with Raman amplification=OSC disconnection. In this case, even when the main signal disconnection has not occurred in the ROADM with Raman amplification, the APSD is applied due to the OSC disconnection, and the main signal disconnection occurs.

A problem occurring in the ROADM with Raman amplification described above will be described below with reference to FIGS. 4A to 4C.

FIG. 4A illustrates a state of each signal due to transmission line disconnection between the NodeA (100A) and the NodeB (100B). When the transmission line disconnection occurs in the transmission line 101a, the main signal transmitted from the NodeA (100A) is lost. However, as a result of the Raman amplifier 111 of the NodeB (100B) causing backward Raman pumping in the transmission line 101a, generated Raman noise remains and becomes noise. As described above, a PD 123p of the optical amplifier 123a of the NodeB (100B) may be unable to detect the main signal disconnection. For this reason, in the NodeB (100B), control for applying APSD is performed by using detection of linkdown of the OSC light (OSC linkdown) as a trigger.

Accordingly, although the main signal is in a normal communication state in the NodeB (100B), the optical amplifier 123a is shut down due to the OSC disconnection such as a sudden failure of the OSC light, and thus the main signal disconnection occurs in operation.

FIG. 4B is a diagram illustrating the main signal and the OSC light. A horizontal axis in FIG. 4B indicates a wavelength, and a vertical axis indicates received power. (a) of FIG. 4B illustrates wavelength setting of the OSC light and the main signal. The OSC light and the main signal have different wavelength bands, are wavelength-multiplexed, and are transmitted through the same optical fiber (transmission line 101). The main signal is WDM light, and the number of wavelengths of the main signal may be, for example, in a range of about 1 to 128 waves. The OSC light is one wave.

(b) of FIG. 4B illustrates the received power of the main signal and the Raman noise illustrated in FIG. 4A. Each of the main signal and the Raman noise has predetermined received power. As illustrated in (b) of FIG. 4B, the Raman noise power may become larger than the main signal power depending on the number of wavelengths.

Even in a case where the main signal disconnection illustrated in FIG. 4A occurs and the received power of the main signal is lost, the Raman noise power is detected due to the return light by the backward Raman pumping in the NodeB (100B).

FIG. 4C illustrates a detection threshold of the main signal disconnection. In the NodeB (100B), a WDMLOS detection threshold Th for determining the main signal disconnection is uniformly set to the same value regardless of the number of wavelengths transmitted as the main signal. At the time of the main signal disconnection, the NodeB (100B) outputs a WDMLOS.

The WDMLOS detection threshold Th illustrated in (a) of FIG. 4C is set to a value (dotted line in (a) of FIG. 4C)) at which the WDMLOS may be detected even when only one wavelength is operated. The WDMLOS detection threshold Th has the same value regardless of the presence or absence of the Raman amplifier. However, in a configuration in which the NodeB (100B) performs Raman amplification, it is assumed that the WDMLOS detection threshold Th illustrated in (a) of FIG. 4C is set. In this case, when the main signal power is lost, it may not be determined that the main signal is lost due to the influence of the Raman noise power larger than the WDMLOS detection threshold Th.

For this reason, as illustrated in (b) of FIG. 4C, it is assumed that the WDMLOS detection threshold Th is set to be relatively high based on the case where the number of wavelengths is large. It is possible to detect the main signal disconnection in this case. However, if the number of wavelengths of the main signal decreases and the received power of the main signal falls below the WDMLOS detection threshold Th, the main signal disconnection is erroneously detected.

For the problem described above, the Raman amplification device 100 that performs backward Raman pumping according to the embodiment monitors the number of wavelengths of the main signal in operation (in transmission) in the transmission line 101 by the wavelength number control, and switches the WDMLOS detection threshold and the APSD determination condition. However, the Raman amplification apparatus 100 may monitor the total power of the main signal during operation (during transmission) by the power control and switch between the WDMLOS detection thresholds and the APSD determination conditions.

### Control in Embodiment

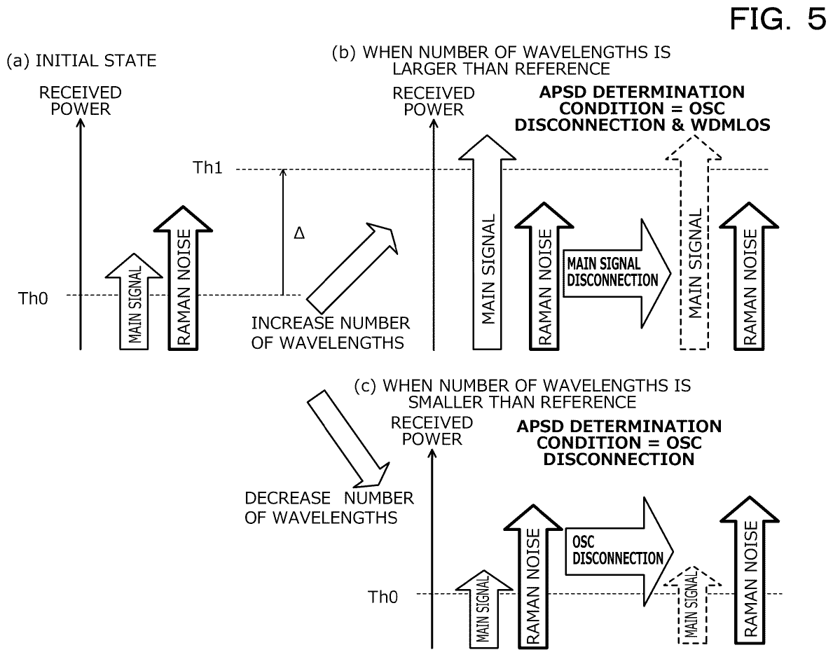

FIG. 5 is an explanatory diagram of a control example in the Raman amplification device according to the embodiment. In an initial state illustrated in (a) of FIG. 5, a WDMLOS detection threshold Th0 is set to a value (reference value) at which both the main signal and the Raman noise may be detected.

As illustrated in (b) of FIG. 5, when the number of wavelengths of the main signal is larger than a predetermined reference value, minimum main signal power becomes higher. In this case, the Raman amplification device 100 performs switching to change the WDMLOS detection threshold Th0 to Th1 (first set value) increased by Δ, and “1. APSD determination condition=AND of OSC disconnection and WDMLOS” is set as a determination condition. Accordingly, when the main signal disconnection occurs, the state of the main signal disconnection may be determined by using the WDMLOS detection threshold Th1. In a case where only OSC disconnection occurs due to a sudden failure of the OSC, since the APSD is not applied, it is possible to avoid the influence on the main signal in the communication state.

As illustrated in (c) of FIG. 5, when the number of wavelengths of the main signal decreases, the Raman amplification device 100 sets “2. APSD determination condition=OSC disconnection”. At this time, the WDMLOS detection threshold Th is maintained at the second set value, for example, at an initial value of Th0 and is not changed. This is based on the fact that the operation with a small number of wavelengths equal to or less than a reference number of wavelengths is rare. Accordingly, the APSD may be applied based on the OSC disconnection.

### Functional Configuration Example Of Raman Amplification Device

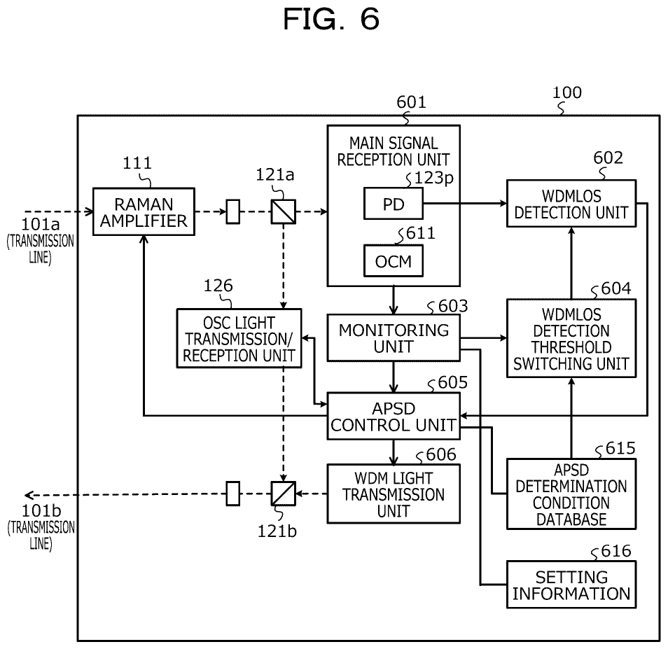

FIG. 6 is a functional block diagram of the Raman amplification device according to the embodiment. In FIG. 6, configurations that are the same as the constituent elements of the NodeN (100B) described above are denoted by the same reference signs. Dotted lines in FIG. 6 indicate optical signals and solid lines indicate electric signals.

The Raman amplification device 100 includes respective functions of the Raman amplifier 111, the multiplexers/demultiplexers 121a and 121b, and the OSC light transmission/reception unit 126 described above. The Raman amplification device 100 includes respective functions of a main signal reception unit 601, a WDMLOS detection unit 602, a monitoring unit 603, a WDMLOS detection threshold switching unit 604, an APSD control unit 605, a WDM light transmission unit 606, an APSD determination condition database 615, and setting information 616.

The PD 123p of the main signal reception unit 601 detects a main signal transmitted from the NodeA (100A) via the transmission line 101a, and an OCM 611 detects the number of wavelengths of the main signal. The main signal reception unit 601 includes the optical amplifier 123a described above. The OCM is an abbreviation for optical channel monitor. The WDMLOS detection unit 602 outputs a WDMLOS signal when detecting the main signal disconnection for the main signal detected by the PD 123p.

The monitoring unit 603 monitors the number of wavelengths of the main signal detected by the OCM 611 by the wavelength number control. In the case of the power control, the monitoring unit 603 monitors the total power of the main signal detected by the PD 123p. The WDMLOS detection threshold switching unit 604 switches the WDMLOS detection threshold Th in accordance with the number of wavelengths of the main signal monitored by the monitoring unit 603 and a WDMLOS detection threshold for each APSD determination condition held in the APSD determination condition database 615. The switching of the WDMLOS detection thresholds Th may be performed based on the total power of the main signal instead of the number of wavelengths.

The WDM light transmission unit 606 includes the optical amplifier 123b described above, and transmits WDM light (main signal) to the NodeA (100A) via the transmission line 101b.

The APSD control unit 605 performs APSD control based on the presence or absence of the OSC disconnection detected by the OSC light transmission/reception unit 126 and the presence or absence of the WDMLOS output of the WDMLOS detection unit 602. At this time, the APSD control unit 605 refers to the APSD determination condition database 615 and the setting information 616. The setting information 616 holds information on the number of wavelengths set in the device, power information of each signal, and bandwidth and signal type information.

According to the variation in the number of wavelengths of the main signal in operation monitored by the monitoring unit 603, as described above, when the monitored number of wavelengths is larger than the number of wavelengths set in the device, the APSD control unit 605 set “1. APSD determination condition=AND of OSC disconnection and WDMLOS”. In a case where the number of wavelengths of the main signal decreases, switching is performed to “2. APSD determination condition=OSC disconnection” only.

Further, the APSD control unit 605 may switch the APSD determination condition based on the variation in the total power of the main signal by the power control, without being limited to switching the APSD determination condition based on the variation in the number of wavelengths of the main signal by the above-described wavelength number control. In the case of the power control, for example, when the monitored total power is larger than the reference power set in the device, the following condition is set “1. APSD determination condition=AND of OSC disconnection and WDMLOS”. When the total power of the main signal decreases, switching is performed to “2. APSD determination condition=OSC disconnection” only.

For the wavelength number control, the monitoring unit 603 also obtains power information of each signal from the setting information 616. Since the number of wavelengths is determined based on the reference power, when there is a main signal having a large power, the number of wavelengths may be counted not by one wave but by more than one wave. The main signals to be monitored are different in the magnitude of power per wave. Therefore, when the total power of the monitored main signal is twice the reference power, the monitoring unit 603 counts the total power as two waves. When the power of the main signal is smaller than the reference power, the number of wavelengths may be counted as the number of wavelengths smaller than one wave, for example, 0.5 waves. When the bandwidth, the signal type, or the like has a relationship with the signal power, the monitoring unit 603 may also obtain the bandwidth or the signal type information from the setting information 616. For example, the wider the bandwidth, the greater the signal power. This makes it possible to cope with the power of the main signal that varies the way of counting the number of wavelengths when the wavelength number control is performed.

The monitoring unit 603 may replace the power of the main signal communicated with the corresponding number of wavelengths, replace the reference power with the reference number of wavelengths, and perform the APSD control based on the replaced number of wavelengths and the replaced reference number of wavelengths.

In a case where the monitored number of wavelengths is larger than the number of wavelengths set in the device, the APSD control unit 605 shuts down the WDM light transmission unit 606 and the Raman amplifier 111 based on “1. APSD determination condition=AND condition of OSC disconnection and WDMLOS”. At this time, the APSD control unit 605 notifies the OSC light transmission/reception unit 126 of an APSD request to the NodeA (100A) by using an OSC signal.

In a case where the monitored number of wavelengths is smaller than the number of wavelengths set in the device, the APSD control unit 605 shuts down the WDM light transmission unit 606 and the Raman amplifier 111 based on “2. APSD determination condition=OSC disconnection” only. At this time, the APSD control unit 605 notifies the OSC light transmission/reception unit 126 of the APSD request to the NodeA (100A) by using the OSC signal. In the power control, the APSD control section 605 may shut down the WDM optical transmission section 606 and the Raman amplifier 111, based on “2. APSD determination condition=OSC disconnection” only, when the total power of the monitored main signal is smaller than the reference power set in the device.

### Hardware Configuration Example of Control Unit of Raman Amplification Device

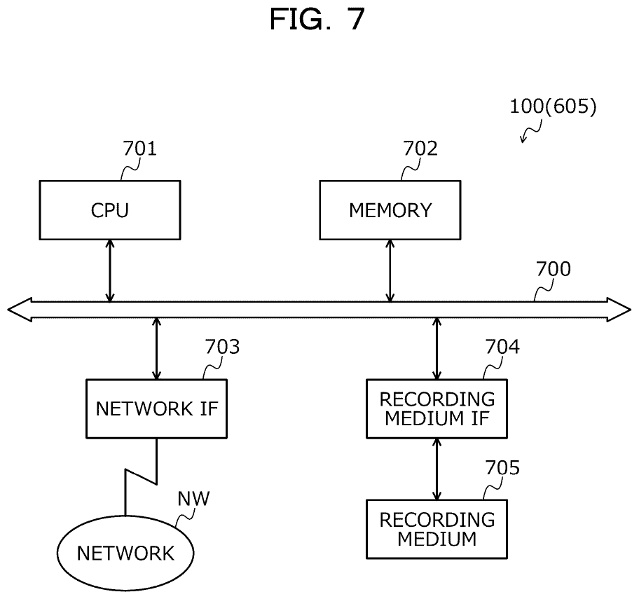

FIG. 7 is a diagram illustrating a hardware configuration example of the control unit of the Raman amplification device. For example, a function related to the APSD control of the Raman amplification device 100 may be configured by general-purpose hardware illustrated in FIG. 7.

Among the functions illustrated in FIG. 6, mainly the APSD control unit 605 and the function related to signal processing, for example, the function of performing electric signal processing in the main signal reception unit 601 to the WDM light transmission unit 606 may be realized by using the hardware configuration illustrated in FIG. 7.

An example illustrated in FIG. 7 includes a processor (CPU) 701 such as a central processing unit (CPU), a memory 702, a network interface (IF) 703, a recording medium IF 704, and a recording medium 705. The respective constituent elements are coupled to each other through a bus 700.

The processor 701 is a control unit that mainly performs the APSD control. The processor 701 may have a plurality of cores. The memory 702 includes, for example, a read-only memory (ROM), a random-access memory (RAM), a flash ROM, and the like. For example, the flash ROM stores a control program, the ROM stores an application program, and the RAM is used as a work area of the processor 701. The program stored in the memory 702 causes the processor 701 to execute coded processing by being loaded into the processor 701.

The network IF 703 serves as an interface with a network NW and controls input and output of information to and from the outside. For example, the network NW is not limited to a wired or wireless electric transmission line, and an optical transmission line via the transmission line 101 may be used.

According to the control of the processor 701, the recording medium IF 704 controls read and write of data from and to the recording medium 705. The recording medium 705 stores data written under the control of the recording medium IF 704.

Besides the constituent elements described above, for example, an input device, a display, and the like may be coupled via an IF.

By executing the program, the processor 701 illustrated in FIG. 7 may realize the APSD control unit 605 and the function related to each electric signal processing in the main signal reception unit 601 to the WDM light transmission unit 606 illustrated in FIG. 6.

### Overview of APSD Control

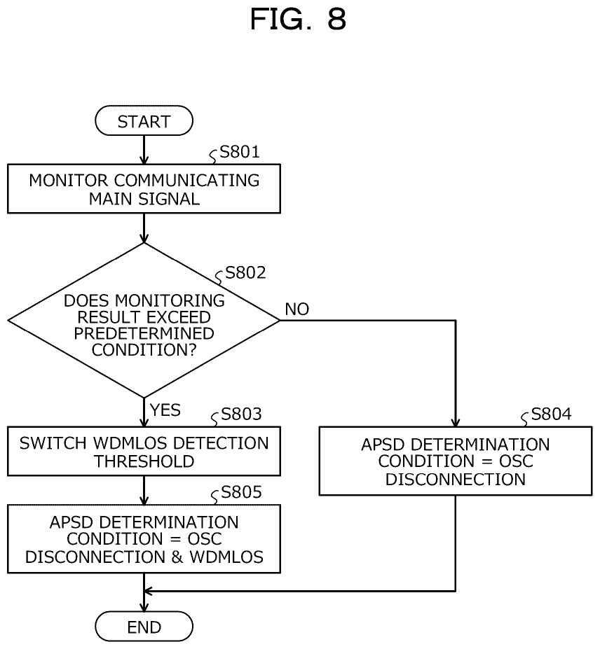

FIG. 8 is a flowchart illustrating an overview of a processing example of APSD control performed by the Raman amplification device. FIG. 8 illustrates processing related to switching of the APSD determination condition, which is mainly executed by the APSD control unit 605 (the processor 701 in FIG. 7) illustrated in FIG. 6.

First, the APSD control unit 605 monitors the main signal communicated over the transmission line 101a (operation S801). Next, the APSD control unit 605 determines whether the monitoring result of the main signal communicated monitored in operation S801 exceeds a predetermined condition (operation S802). As the predetermined condition, for example, the number of wavelengths is used in the wavelength number control, and the power is used in the power control.

As a result of the determination, when the monitoring result of the main signal exceeds the predetermined condition (operation S802: Yes), the APSD control unit 605 proceeds to processing of operation S803. The case where the monitoring result of the main signal exceeds the predetermined condition corresponds to, for example, the case where the number of wavelengths is larger than the reference number of wavelengths in the wavelength number control, and the case where the total power of the main signal communicated is larger than the reference power in the power control.

On the other hand, when the monitoring result of the main signal communicated is less than the predetermined condition (operation S802: No), the APSD control unit 605 proceeds to processing of operation S804. The case where the monitoring result of the main signal is below the predetermined condition corresponds to, for example, the case where the number of wavelengths is smaller than the reference number of wavelengths in the wavelength number control, and the case where the total power of the main signal communicated is smaller than the reference power in the power control.

In operation S803, the APSD control unit 605 switches the WDMLOS detection threshold Th (operation S803). The WDMLOS detection threshold Th is switched to become higher from the default reference value in accordance with the number of communicating wavelengths or the total power of the main signal. Thereafter, the APSD control unit 605 sets “APSD determination condition=AND of OSC disconnection and WDMLOS” (operation S805).

In operation S804, the APSD control unit 605 sets “APSD determination condition=OSC disconnection” only (operation S804). By the processing of operation S805 or operation S804, the APSD control unit 605 ends the processing related to the switching of the APSD determination condition described above.

### Example of Setting WDMLOS Detection Threshold

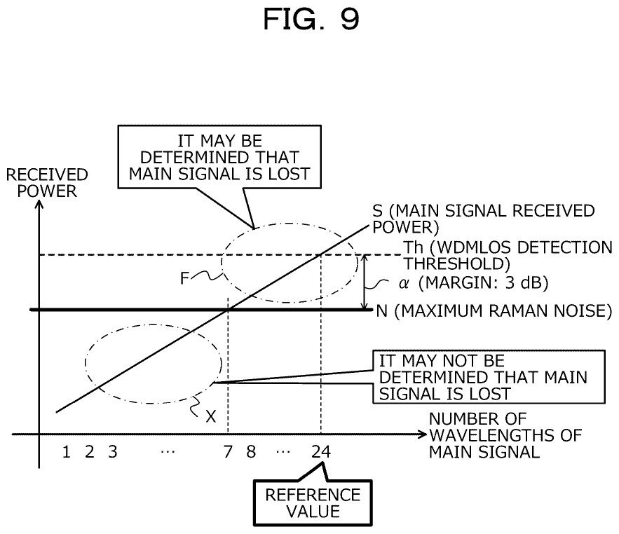

FIG. 9 is a chart illustrating an example of setting the WDMLOS detection threshold. A horizontal axis in FIG. 9 indicates the number of wavelengths of the main signal, and a vertical axis indicates received power of the main signal. The received power of the main signal indicates minimum received power at each number of wavelengths. For the WDMLOS detection threshold Th, maximum Raman noise N is obtained based on a fiber type (kind) of the transmission line 101 and Raman gain of the Raman amplifier 111, and the number of wavelengths at which main signal received power S in the main signal reception unit 601 becomes larger than the power of the Raman noise N is set as a reference value. In FIG. 9, the horizontal axis may be replaced with a set value (reference power) of the power of the main signal.

As illustrated in FIG. 9, the main signal received power S has a characteristic in which the received power becomes larger as the number of wavelengths becomes larger, and an intersection between the main signal received power S and the maximum Raman noise N is at 7 wavelengths. In this case, when the WDMLOS detection threshold Th is set in a region X in which the number of wavelengths is smaller than 7 wavelengths, it is impossible to determine the state where the main signal is lost due to the influence of the power of the Raman noise.

When the WDMLOS detection threshold Th is set in a region F in which the number of wavelengths exceeds 7 wavelengths, it is possible to determine the main signal disconnection without being affected by the power of the Raman noise. In the example illustrated in FIG. 9, the reference value of the WDMLOS detection threshold Th is set to 24 wavelengths as the number of wavelengths corresponding to the main signal received power S with a margin a (for example, 3 dB) from the maximum Raman noise N for safety.

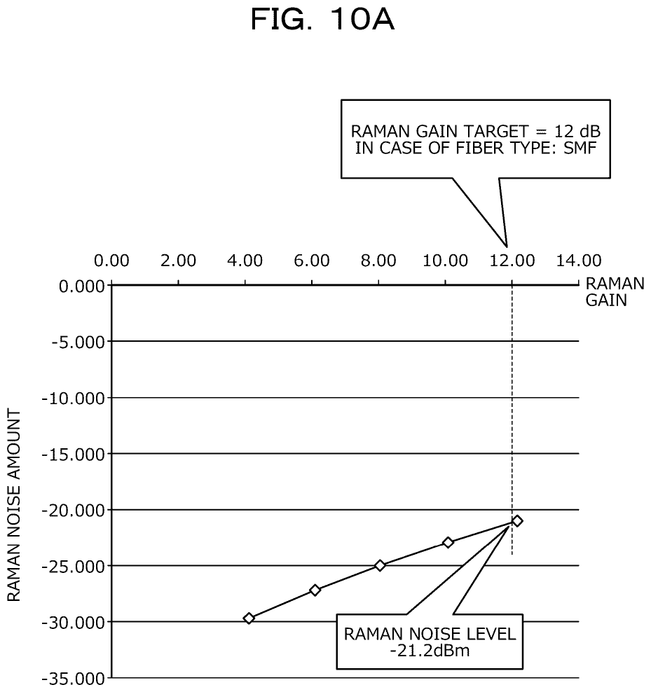

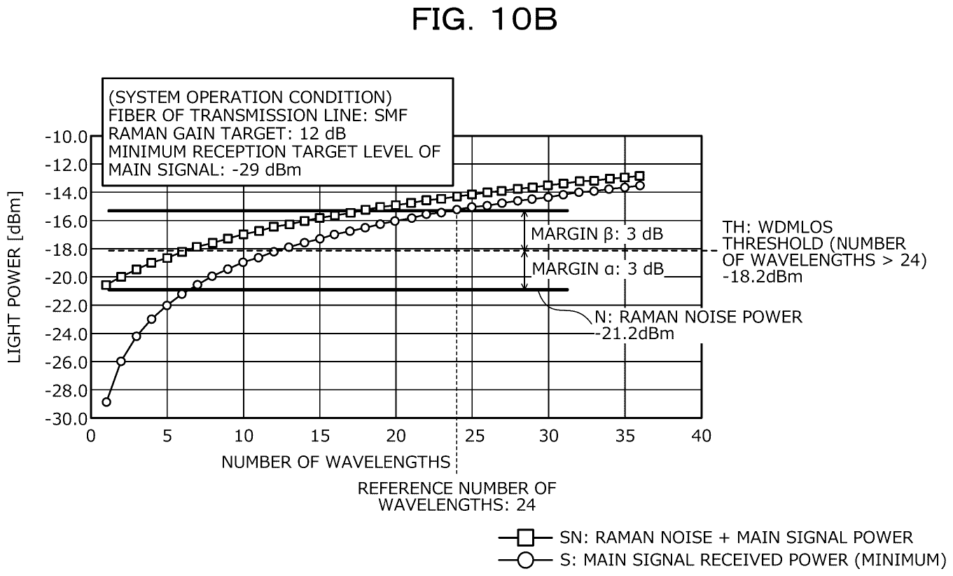

FIGS. 10A and 10B are charts illustrating specific examples of setting reference values of the WDMLOS detection threshold and the number of wavelengths.

FIG. 10A is a chart illustrating a simulation result of a Raman noise generation amount. A horizontal axis in FIG. 10A indicates Raman gain, and a vertical axis indicates a Raman noise amount. A Raman gain target in a case where the fiber type of the transmission line 101 is the SMF is 12 dB. Based on these two parameters of the fiber type and the Raman gain target, a level of the Raman noise N of −21.2 dBm on the Raman gain target of 12 dB is obtained.

FIG. 10B is a chart for describing the determination of the WDMLOS and a reference value of the number of wavelengths. A horizontal axis in FIG. 10B indicates the number of wavelengths of the main signal, and a vertical axis indicates light power. A characteristic of the main signal received power (minimum) S is indicated by ○ marks in FIG. 10B. A received power characteristic SN of Raman noise+the main signal is indicated by □ marks.

Under the system operation condition illustrated in FIG. 10B, the fiber type of the transmission line 101 is SMF, the Raman gain target is 12 dB, and the minimum reception target level of the main signal is −29 dBm.

As for the reference value of the number of wavelengths, a value “−18.2dBm” larger by 3 dB as the margin a than the power of the Raman noise N of “−21.2 dBm” indicated in FIG. 10A is set as the WDMLOS detection threshold Th. The number of wavelengths at which the main signal received power S exceeds the WDMLOS detection threshold Th is set as the reference value (reference number of wavelengths).

As described above, in FIG. 10B, the margin a is a margin (for example, 3 dB) for the variation in the power of the Raman noise N caused by the fiber characteristic of the transmission line 101 or the like. A margin β is a margin (for example, 3 dB) for the variation in the main signal received power S caused by a level deviation between the wavelengths due to the optical level control or the like. In the example of FIG. 10B, for the power of the Raman noise N of “−21.2 dBm”, the reference number of wavelengths of 24 is set from an intersection with the main signal received power S with the margin α+β. In FIG. 10B, the main signal reception power S may be used as the reference power.

The WDMLOS detection threshold Th and the reference number of wavelengths take different values depending on the individual parameters 1. to 4below.
1. Optical wavelength band (C-band/L-band) of transmission system,
2. Fiber type of transmission line 101,
3. Raman gain target of Raman amplifier 111, and
4. Minimum reception target of main signal

### Example of APSD Determination Condition

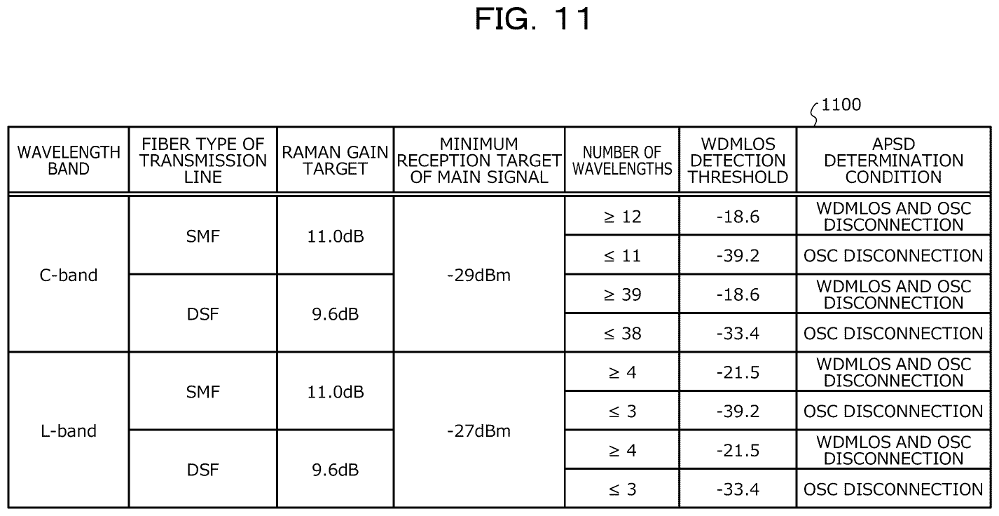

FIG. 11 is a chart illustrating an example of setting the APSD determination condition. APSD determination condition setting information 1100 illustrated in FIG. 11 is set in the APSD determination condition database 615.

For the APSD determination condition setting information 1100, the number of wavelengths, the WDMLOS detection threshold Th, and the APSD determination condition for each combination of the aforementioned individual parameters of 1. to 4. are set. The number of wavelengths is set by being divided into two for each number of wavelengths in operation with respect to the reference number of wavelengths. The setting by divided may be performed based on the magnitude of the reference power of the main signal.

For example, 1. optical wavelength band of transmission system of “C-band”, 2. fiber type of transmission line 101 of “SMF”, 3. Raman gain target of “11” dB, and 4. minimum reception target of main signal of “−29 dBm” are set. For these four parameters, when the number of communicating wavelengths is “12 or more”, a WDMLOS detection threshold Th of “−18.6” dBm and an APSD determination condition of “WDMLOS & OSC disconnection” are set. In a case where the number of wavelengths is “11 or less”, a WDMLOS detection threshold Th of “−39.2” dBm and an APSD determination condition of “OSC disconnection” are set.

1. Optical wavelength band of transmission system of “C-band”, 2. fiber type of transmission line 101 of “DSF”, 3. Raman gain target of “9.6” dB, and 4. minimum reception target of main signal of “−29 dBm” are set. The DSF is an abbreviation for dispersion shifted fiber. For these four parameters, when the number of communicating wavelengths is “39 or more”, a WDMLOS detection threshold Th of “−18.6” dBm and an APSD determination condition of “WDMLOS & OSC disconnection” are set. In a case where the number of wavelengths is “38 or less”, a WDMLOS detection threshold Th of “−33.4” dBm and an APSD determination condition of “OSC disconnection” are set.

1. Optical wavelength band of transmission system of “L-band”, 2. fiber type of transmission line 101 of “SMF”, 3. Raman gain target of “11” dB, and 4. minimum reception target of main signal of “−27 dBm” are set. For these four parameters, when the number of communicating wavelengths is “4 or more”, a WDMLOS detection threshold Th of “−21.5” dBm and an APSD determination condition of “WDMLOS & OSC disconnection” are set. In a case where the number of wavelengths is “3 or less”, a WDMLOS detection threshold Th of “−39.2” dBm and an APSD determination condition of “OSC disconnection” are set.

1. Optical wavelength band of transmission system of “L-band”, 2. fiber type of transmission line 101 of “DSF”, 3. Raman gain target of “9.6” dB, and 4. minimum reception target of main signal of “−27 dBm” are set. For these four parameters, when the number of communicating wavelengths is “4 or more”, a WDMLOS detection threshold Th of “−21.5” dBm and an APSD determination condition of “WDMLOS & OSC disconnection” are set. In a case where the number of wavelengths is “3 or less”, a WDMLOS detection threshold Th of “−33.4” dBm and an APSD determination condition of “OSC disconnection” are set.

The APSD control unit 605 accesses the monitoring unit 603, the setting information 616, and the APSD determination condition database 615. The APSD control unit 605 reads setting information corresponding to the aforementioned parameters of 1. to 4. of the transmission system in operation from the APSD determination condition setting information 1100, and determines the WDMLOS detection threshold Th and the APSD determination condition for each number of wavelengths.

### Example of Overall Processing of APSD Control

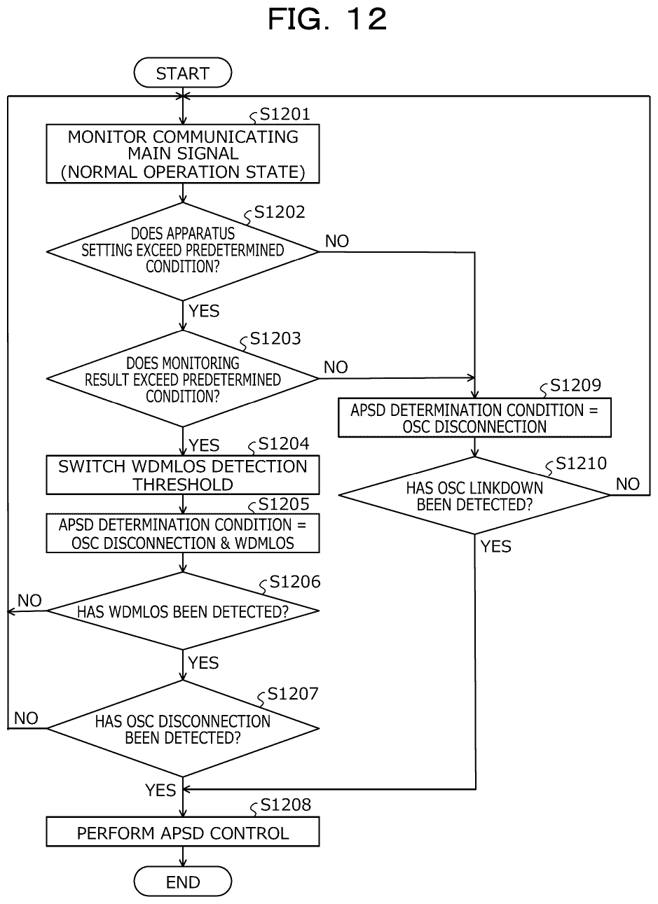

FIG. 12 is a flowchart illustrating an example of overall processing of APSD control performed by the Raman amplification device. Processing in FIG. 12 indicates the overall processing related to the APSD control executed by each function (processor 701 in FIG. 7) of the Raman amplification device 100 indicated in FIG. 6.

First, the Raman amplification device 100 monitors the main signal communicated over the transmission line 101a (operation S1201). Next, the Raman amplification device 100 determines whether the current device setting (setting information 616) exceeds a predetermined condition (operation S1202). For example, in the wavelength number control, it is determined whether the number of wavelengths of the current device setting (setting information 616) is larger than the reference number of wavelengths. In the power control, it is determined whether the total power of the main signal calculated from the current device setting (setting information 616) is larger than the reference power.

In the wavelength number control, when the result of the determination in operation S1202 is that the number of wavelengths set in the device is greater than the reference number of wavelengths (operation S1202: Yes), the Raman amplification device 100 proceeds to processing of operation S1203. On the other hand, when the number of wavelengths set in the device is not larger than the reference number of wavelengths (operation S1203: No), the Raman amplification device 100 proceeds to processing of operation S1209.

In the power control, when the result of the determination in operation S1202 is that the total power of the main signal calculated from the device setting is larger than the reference power (operation S1202: Yes), the Raman amplification device 100 proceeds to the processing of operation S1203. On the other hand, when the total power of the main signal calculated from the device setting is smaller than the reference power (operation S1202: No), the Raman amplification device 100 proceeds to the processing of operation S1209.

In operation S1203, the Raman amplification device 100 determines whether the monitoring result exceeds a predetermined condition. For example, in the wavelength number control, the Raman amplification device 100 determines whether the number of received wavelengths is larger than the reference number of wavelengths. When the number of received wavelengths is larger than the number of reference wavelengths (operation S1203: Yes), the Raman amplification device 100 proceeds to the processing of operation S1204. On the other hand, when the number of received wavelengths is not larger than the number of reference wavelengths (operation S1203: No), the Raman amplification device 100 proceeds to the processing of operation S1209.

In the power control, the Raman amplification device 100 determines whether the total power of the received main signal is larger than the reference power (operation S1203). When the determination result indicates that the total power of the main signal is larger than the reference power (operation S1203: Yes), the Raman amplification device 100 proceeds to the processing of operation S1204. On the other hand, when the total power of the main signal is not larger than the reference power (operation S1203: No), the Raman amplification device 100 proceeds to the processing of operation S1209.

In operation S1204, the Raman amplification device 100 switches the WDMLOS detection threshold Th (operation S1204). In this switching, the Raman amplification device 100 refers to the APSD determination condition setting information 1100, and changes the setting to the WDMLOS detection threshold Th corresponding to the number of communicating wavelengths or the main signal power based on the four parameters of 1. to 4. described above.

Next, the Raman amplification device 100 sets APSD determination condition=OSC disconnection & WDMLOS (operation S1205).

Thereafter, the Raman amplification device 100 determines whether a WDMLOS has been detected (operation S1206). As a result of the determination, in a case where the WDMLOS has been detected (operation S1206: Yes), the Raman amplification device 100 proceeds to processing of operation S1207. On the other hand, when the WDMLOS has not been detected (operation S1206: No), the Raman amplification device 100 returns to the processing of operation S1201.

In operation S1207, the Raman amplification device 100 determines whether OSC disconnection has been detected (operation S1207). As a result of the determination, in a case where the OSC disconnection has been detected (operation S1207: Yes), the Raman amplification device 100 proceeds to processing of operation S1208. On the other hand, when the OSC disconnection has not been detected (operation S1207: No), the Raman amplification device 100 returns to the processing of operation S1201.

In operation S1209, the Raman amplification device 100 sets APSD determination condition=OSC disconnection (operation S1209).

Thereafter, the Raman amplification device 100 determines whether OSC linkdown has been detected (operation S1210). When the OSC linkdown has been detected (operation S1210: Yes), the Raman amplification device 100 proceeds to processing of operation S1208. On the other hand, when the OSC linkdown has not been detected (operation S1210: No), the Raman amplification device 100 returns to the processing of operation S1201.

In operation S1208, the Raman amplification device 100 executes control related to the APSD based on the APSD determination condition determined in operation S1205 or operation S1209 (operation S1208).

The Raman amplification device according to the embodiment described above performs Raman amplification of the optical signal in the transmission line by Raman pumping. The Raman amplification device monitors the main signal communicated by the optical signal, and switches the WDMLOS detection threshold for determining the presence or absence of an alarm (WDMLOS) output at the time of transmission line disconnection in accordance with the monitoring result of the main signal. When the monitoring result of the communicated main signal exceeds the predetermined condition, the presence or absence of APSD control is determined by using APSD determination condition 1 based on integration of OSC interruption and WDMLOS. On the other hand, when the monitoring result of the communicated main signal is below the predetermined condition, the presence or absence of the APSD control is determined by using the APSD determination condition 2 based on the OSC disconnection. For example, the monitoring may be monitoring the power of the communicated main signal, in this case the predetermined condition is a predetermined reference power. Furthermore, the monitoring may be monitoring the number of wavelengths of the communicated main signal, and in this case, the predetermined condition is a predetermined reference number of wavelengths. Furthermore, the monitoring may be monitoring the power of the communicated main signal, the power of the communicated main signal may be replaced with the corresponding number of wavelengths, and the predetermined condition may be a predetermined reference number of wavelengths. Accordingly, the Raman amplification device that performs backward Raman pumping is affected by the Raman noise due to the backward Raman pumping at the time of fiber disconnection of the transmission line, according to the embodiment, it is possible to suppress application of the APSD when the OSC disconnection occurs in the communication state of the main signal, and thus to avoid unexpected main signal disconnection.

Further, the Raman amplification device may determine the number of wavelengths of the communicated main signal under a certain signal power condition, and may count one signal by the number of wavelengths other than one wave under other conditions. This makes it possible to cope with the power of the main signal that varies the way of counting the number of wavelengths when APSD control based on the number of wavelengths is performed.

In a case where the power of the communicated main signal is smaller than the reference power or the number of wavelengths of communicated main signal is smaller than the reference number of wavelengths, the control unit of the Raman amplification device sets the WDMLOS detection threshold to the second set value, for example, the reference value of an initial setting. In a case where the power of the communicated main signal is larger than the reference power or the number of wavelengths of communicated main signal is larger than the reference number of wavelengths, the control unit of the Raman amplification device sets the WDMLOS detection threshold to the first set value. For example, the first set value is larger than the reference value and different from the second set value. Accordingly, the WDMLOS detection threshold may be set to an appropriate value corresponding to the power of the main signal or the variation in the number of wavelengths of the main signal, and the APSD control may be performed more accurately.

The Raman amplification device in which the reference power or the reference number of wavelengths is set to the power or the number of wavelengths at which the received power of the communicated main signal is larger than the Raman noise power, based on the fiber type of the transmission line, the Raman noise power of the Raman amplification, and the Raman amplification gain may be used. Based on these various parameters, it is possible to correctly monitor the number of wavelengths of the communicated main signal by using the reference power or the reference number of wavelengths applied to the system to be operated.

The Raman amplification device in which a WDMLOS detection threshold is set to a value based on one or a plurality of combinations of the wavelength band of the transmission line, the fiber type of the transmission line, the noise power of the Raman amplification, and the received power of the main signal may be used. Based on these various parameters, the presence or absence of the WDMLOS output may be correctly determined by the WDMLOS detection threshold applied to the system to be operated.

The control unit of the Raman amplification device may be set the WDMLOS detection threshold according to the power or the number of wavelengths of the communicated main signal. For example, the WDMLOS detection threshold may be variably set according to the power or the number of wavelengths of the communicated main signal. Further, for setting of the fixed value of the WDMLOS detection threshold, in a case where the power of the communicated main signal is larger than the reference power or the number of wavelengths of the communicated main signal is larger than the reference number of wavelengths, the control unit of the Raman amplification device sets the WDMLOS detection threshold to the first set value and performs APSD determination according to the APSD determination condition 1, and does not perform the APSD control at the time of OSC disconnection in a state where the main signal is in a communication state. Accordingly, even when the OSC disconnection occurs in the communication state of the main signal, it is possible to suppress the APSD and avoid the main signal disconnection.

In a case where the power of the communicated main signal is smaller than the reference power or the number of wavelengths of the communicated main signal is smaller than the reference number of wavelengths, the control unit of the Raman amplification device sets the WDMLOS detection threshold to a second set value and performs APSD determination according to the APSD determination condition 2, and performs the APSD control at the time of OSC disconnection. Accordingly, in a case where the power of the communicated main signal is smaller than the reference power or the number of wavelengths of the communicated main signal is smaller than the reference number of wavelengths, when the OSC disconnection occurs, the APSD control may be appropriately performed.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A Raman amplification device that Raman-amplifies an optical signal in a transmission line by Raman pumping, the Raman amplification device comprising:
a memory; and
a processor coupled to the memory and configured to:
monitor a first signal communicated by the optical signal;
set a threshold level of an alarm (WDMLOS) detection for determining whether the alarm is output at a time of transmission line disconnection in accordance with a monitoring result of the first signal;
determine whether auto power shut down (APSD) control is performed by using a first APSD determination condition based on integration of optical supervisory channel (OSC) disconnection and the alarm, in a case where the monitoring result of the communicated first signal exceeds a predetermined condition; and
determine whether the APSD control is performed by using a second APSD determination condition based on the OSC disconnection, in a case where the monitoring result of the communicated first signal is lower than the predetermined condition.

2. The Raman amplification device according to claim 1,
wherein the processor is configured to monitor power of the communicated first signal, and
wherein the predetermined condition is a predetermined reference power.

3. The Raman amplification device according to claim 1,
wherein the processor is configured to monitor a number of wavelengths of the communicated first signal, and
wherein the predetermined condition is a predetermined reference number of wavelengths.

4. The Raman amplification device according to claim 1,
wherein the processor is configured to monitor power of the communicated first signal, and replaces the power with a corresponding number of wavelengths, and
wherein the predetermined condition is a predetermined reference number of wavelengths.

5. The Raman amplification device according to claim 4, wherein the number of wavelengths of the communicated first signal is determined by a predetermined signal power condition, and one signal may be counted by the number of wavelengths other than one wave under other conditions.

6. The Raman amplification device according to claim 2, wherein the processor is configured to set the threshold level according to the power of the communicated first signal.

7. The Raman amplification device according to claim 3, wherein the processor is configured to set the threshold level according to the number of wavelengths of the communicated first signal.

8. The Raman amplification device according to claim 2, wherein the predetermined reference power is set to a power at which received power of the communicated first signal becomes larger than Raman noise power of a Raman amplification, based on a fiber type of the transmission line, the Raman noise power, and a Raman amplification gain.

9. The Raman amplification device according to claim 3, wherein the reference number of wavelengths is set to a number of wavelengths at which received power of the communicated first signal becomes larger than Raman noise power of a Raman amplification, based on a fiber type of the transmission line, the Raman noise power, and Raman amplification gain of the Raman amplification.

10. The Raman amplification device according to claim 1, wherein the threshold level is set to a value based on at least one combination of a wavelength band of the transmission line, a fiber type of the transmission line, noise power of the Raman amplification, and received power of the first signal.

11. The Raman amplification device according to claim 2,
wherein the processor is configured to set the threshold level to a first set value and determine whether the APSD control is performed by using the first APSD determination condition, in a case where the power of the communicated first signal is larger than the reference power, and
wherein the processor is configured not to perform the APSD control at a time of the OSC disconnection in a state where the first signal is in a communication state.

12. The Raman amplification device according to claim 3,
wherein the processor is configured to set the threshold level to a first set value and determine whether the APSD control is performed by using the first APSD determination condition, in a case where the number of wavelengths of the communicated first signal is larger than the reference number of wavelengths, and
wherein the processor is configured not to perform the APSD control at a time of the OSC disconnection in a state where the first signal is in a communication state.

13. The Raman amplification device according to claim 2,
wherein the processor is configured to set the threshold level to a second set value and determine whether the APSD control is performed by using the second APSD determination condition, in a case where the power of the communicated first signal is smaller than the reference power, and
wherein the APSD control is performed at a time of the OSC disconnection.

14. The Raman amplification device according to claim 3,
wherein the processor is configured to set the threshold level to a second set value and determine whether the APSD control is performed by using the second APSD determination condition, in a case where the number of wavelengths of the communicated first signal is smaller than the reference number of wavelengths, and
wherein the APSD control is performed at a time of the OSC disconnection.

15. A Raman amplification method of a Raman amplification device that Raman-amplifies an optical signal in a transmission line by Raman pumping, the Raman amplification method comprising:
monitoring a first signal communicated by the optical signal;
setting a threshold level of an alarm (WDMLOS) detection for determining whether the alarm is output at a time of transmission line disconnection in accordance with a monitoring result of the first signal;
determining whether auto power shut down (APSD) control is performed by using a first APSD determination condition based on integration of optical supervisory channel (OSC) disconnection and the alarm, in a case where the monitoring result of the communicated first signal exceeds a predetermined condition; and
determining whether the APSD control is performed by using a second APSD determination condition based on the OSC disconnection, in a case where the monitoring result of the communicated first signal is lower than the predetermined condition, by a processor.

16. The Raman amplification method according to claim 15,
wherein the processor monitors power of the communicated first signal, and
wherein the predetermined condition is a predetermined reference power.

17. The Raman amplification method according to claim 15,
wherein the processor monitors a number of wavelengths of the communicated first signal, and
wherein the predetermined condition is a predetermined reference number of wavelengths.

18. The Raman amplification method according to claim 15,
wherein the processor monitors power of the communicated first signal, replaces the power with a corresponding number of wavelengths, and replaces a reference power with a predetermined reference number of wavelengths, and
wherein the predetermined condition is the predetermined reference number of wavelengths.
